(19) United States
(12) Patent Application Publication
(10) Pub. No.: US 2016/0188984 A1
(43) Pub. Date: Jun. 30, 2016

(54) LANE PARTITION LINE RECOGNITION APPARATUS

(71) Applicant: DENSO CORPORATION, Kariya-city (JP)

(72) Inventors: Taiki Kawano, Nishio-shi (JP); Naoki Kawasaki, Kariya-shi (JP); Tomohiko Tsuruta, Nukata-gun (JP); Shunsuke Suzuki, Kariya-shi (JP)

(21) Appl. No.: 14/981,632

(22) Filed: Dec. 28, 2015

(30) Foreign Application Priority Data
Dec. 25, 2014 (JP) 2014-261709

(51) Int. Cl. G06K 9/00; H04N 7/18

(52) U.S. Cl. CPC G06K 9/00798; G06K 9/00771; H04N 7/185

(57) ABSTRACT

A lane partition line recognition apparatus for recognizing left-side and right-side lane partition lines of a traveling lane of a roadway in which a vehicle carrying the apparatus is traveling based on a forward image captured by a vehicle-mounted camera. The apparatus includes an offset detector configured to detect an offset amount indicative of a positional relationship between each of the left-side and right-side recognized lane partition lines and the vehicle and a predictor configured to, if only one of the left and right lane partition lines of the traveling lane of the subject vehicle is recognized, stochastically predict a position of the unrecognized one of the left and right lane partition lines based on the offset amount detected by the offset detector.

### CROSS-REFERENCE TO RELATED APPLICATION

This application is based on and claims the benefit of priority from earlier Japanese Patent Applications No. 2014-261709 filed Dec. 25, 2014, the descriptions of which are incorporated herein by reference.

### BACKGROUND

1. Technical Field

The present invention relates to an apparatus for recognizing lane partition lines on opposite sides of a traveling lane based on an image captured by a vehicle-mounted camera.

2. Related Art

During traveling of a vehicle, one of the left-side and right-side lane partition lines of a traveling lane may become undetectable due to breaking or smearing of the one of the left-side and right-side lane partition lines. A lane partition line recognition apparatus as disclosed in Japanese Patent Application Laid-Open Publication No. 2003-44836 is configured to estimate a position of the unrecognized one of the left-side and right-side lane partition lines based on lane width data of the traveling lane of the vehicle and a plurality of sample points along the left-side and right-side lane partition lines acquired when they were successfully recognized.

The lane partition line recognition apparatus disclosed in Japanese Patent Application Laid-Open Publication No. 2003-44836 is configured to use the lane width calculated when both the left-side and right-side lane partition lines were recognized as a lane width when one of the left-side and right-side lane partition lines has become undetectable. Therefore, when the unrecognized one of the left-side and right-side lane partition lines becomes detectable again, redetection of the unrecognized one of the left-side and right-side lane partition lines may be started at a position predicted based on the previous lane width, that is, the lane width calculated when both the left-side and right-side lane partition lines were recognized.

However, when the unrecognized one of the left-side and right-side lane partition lines of the traveling lane becomes detectable again, the lane width may have changed from the previous lane width. In such a case, if redetection of the unrecognized one of the left-side and right-side lane partition lines is started at the position predicted based on the previous lane width, the unrecognized one of the left-side and right-side lane partition lines may fail to be detected or a roadside object may be incorrectly recognized as a white line.

In consideration of the foregoing, exemplary embodiments of the present invention are directed to providing a lane partition line recognition apparatus that can provide improved performance of detecting an unrecognized one of left-side and right-side lane partition lines when it becomes detectable again.

### SUMMARY

In accordance with an exemplary embodiment of the present invention, there is provided a lane partition line recognition apparatus for recognizing left-side and right-side lane partition lines of a traveling lane of a roadway in which a vehicle carrying the apparatus is traveling based on a forward image captured by a vehicle-mounted camera. The vehicle carrying the apparatus is hereinafter referred to as a subject vehicle. The apparatus includes: an offset detector configured to detect an offset amount indicative of a positional relationship between each of the left-side and right-side recognized lane partition lines and the subject vehicle, and a predictor configured to, if only one of the left and right lane partition lines of the traveling lane of the subject vehicle is recognized, stochastically predict a position of the unrecognized one of the left and right lane partition lines based on the offset amount detected by the offset detector.

In the above embodiment, the offset amount indicative of a positional relationship between the recognized lane partition line and the subject vehicle is detected. The position of the unrecognized lane partition line is stochastically predicted based on the offset amount. Generally, the subject vehicle travels in the lateral center of its traveling. Therefore, even if the lane width of the traveling lane of the subject vehicle has changed during only one of the left-side and right-side white lines being recognized, the position of the unrecognized one of the left-side and right-side white lines can be predicted based on the offset amount between the recognized one of the left-side and right-side white lines and the subject vehicle. When the unrecognized one of the left-side and right-side lane partition lines becomes detectable again, this can prevent a roadside object or the like from being incorrectly recognized as a white line, thereby providing improved performance of redetecting the unrecognized one of the left-side and right-side lane partition lines of the traveling lane.

### BRIEF DESCRIPTION OF THE DRAWINGS

FIG. 1 is an example of mounting positions of a vehicle-mounted camera and various sensors in accordance with one embodiment of the present invention;

FIG. 2 is a functional block diagram of a white-line recognition apparatus;

FIG. 3 is a first example of predicted positions of the left-side and right-side white lines when only one of the white lines is recognized;

FIG. 4 is a second example of predicted positions of the left-side and right-side white lines when only one of the white lines is recognized;

FIG. 5 is a third example of predicted positions of the left-side and right-side white lines when only one of the white lines is recognized;

FIG. 6 is a fourth example of predicted positions of the left-side and right-side white lines when only one of the white lines is recognized;

FIG. 7 is a fifth example of predicted positions of the left-side and right-side white lines when only one of the white lines is recognized;

FIG. 8 is a modification to the fifth example of FIG. 7; and

FIG. 9 is a flowchart of a white line recognition process.

### DESCRIPTION OF SPECIFIC EMBODIMENTS

Example embodiments will now be described more fully with reference to the accompanying drawings. Example embodiments are provided so that this disclosure will be thorough, and will fully convey the scope to those who are skilled in the art. Numerous specific details are set forth such as examples of specific components to provide a thorough understanding of embodiments of the present disclosure. It will be apparent to those skilled in the art that example embodiments may be embodied in many different forms and that neither should be construed to limit the scope of the disclosure. Identical or equivalent components or components of equal or equivalent action are thereby identified by the same or similar reference numerals, and descriptions of them will not be repeated.

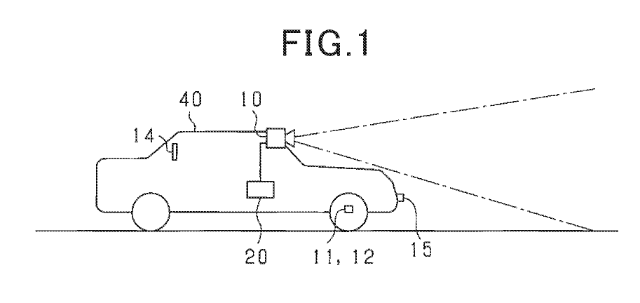

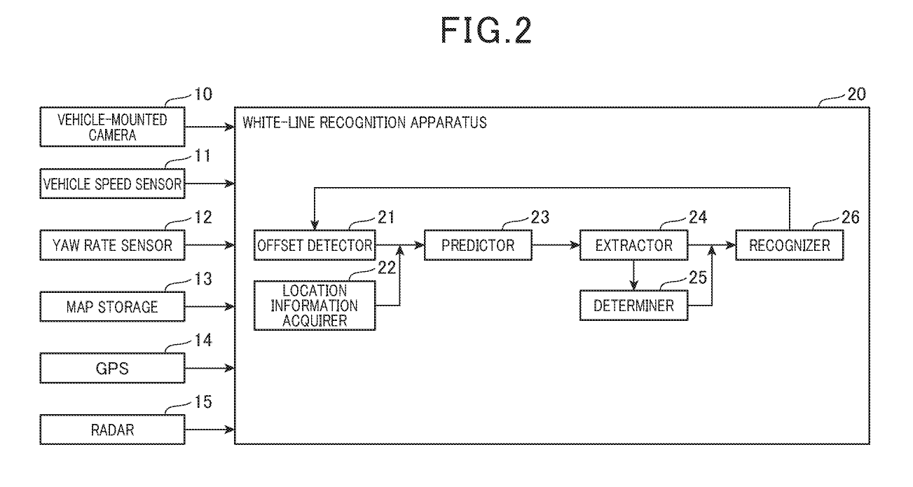

A white-line recognition apparatus (as a lane partition line recognition apparatus) 20 in accordance with one embodiment of the present invention will now be explained with reference to FIGS. 1 and 2. The white-line recognition apparatus 20 of the present embodiment is mounted in a vehicle 40 and configured to recognize white lines (as lane partition lines) that partition a roadway into traffic lanes based on a forward image captured by the vehicle-mounted camera 10.

The vehicle-mounted camera 10 may include at least one of a CCD image sensor, a CMOS image sensor and the like. As shown in FIG. 1, the vehicle-mounted camera 10 may be placed near the top end of a front windshield of the vehicle 40 to capture an image of an area that spans a pre-defined angular range horizontally with respect to a traveling direction. That is, the vehicle-mounted camera 10 captures an image of ambient surroundings including a roadway in front of the vehicle 40.

A vehicle speed sensor 11 is mounted in the vehicle 40 and configured to detect a speed of the vehicle 40. A yaw rate sensor 12 is mounted in the vehicle 40 and configured to detect a yaw rate of the vehicle 40.

A map storage 13 is a storage, such as a hard disk or a DVD, storing map information. The map information includes locations of roadside objects, such as guardrails and the like, and locations of side strips. The GPS 14 is configured to, based on signals transmitted from global positioning system satellites, acquire information indicative of a current location of the subject vehicle 40 and a current time. The information indicative of current location includes a latitude, a longitude, and an altitude of the subject vehicle 40.

At least one radar 15, which may be a millimeter-wave radar, a laser radar, or an ultrasound laser, is attached to a front end of the subject vehicle 40 (e.g., above a bumper) to detect distances and directions from the subject vehicle 40 to respective three-dimensional objects present in forward and lateral directions of the subject vehicle 40.

The white-line recognition apparatus 20 may be a microcomputer including a central processing unit (CPU), a read-only memory (ROM), a random-access memory (RAM), an input/output (I/O) interface, storage and other components. Various functions may be implemented by the CPU executing computer programs stored in the ROM or the like. The white-line recognition apparatus 20 includes, as function blocks corresponding to the various functions, an offset detector 21, a location information acquirer 22, a predictor 23, an extractor 24, a determiner 25, and a recognizer 26.

The offset detector 21 is configured to, for each of white lines recognized by a recognizer 26 (described later), detect an offset amount indicative of a positional relationship between the white line and the subject vehicle 40. More specifically, the offset amount may be a distance from a lateral center of the subject vehicle 40 to the white line or a distance from a side of the subject vehicle 40 to the white line. That is, the offset amount may be any parameter indicative of the positional relationship between the subject vehicle 40 and the white line.

The location information acquirer 22 is configured to, based on a current location of the subject vehicle 40 acquired from the map storage 13 or the GPS 14, acquire information (hereinafter referred to as location information) indicative of locations of roadside objects, such as guardrails, and roadsides. The location information acquirer 22 is further configured to, based on the distances and directions of the three-dimensional objects detected by the radar 15, acquire the location information of the roadside objects.

The predictor 23 is configured to, based on positions of the white line or lines that have been already recognized by the recognizer 26, predict positions of forward white lines to be subsequently recognized by the recognizer 26. When both the left-side and right-side white lines of the traveling lane of the subject vehicle 40 are recognized by the recognizer 26, the predictor 23 predicts forward white line traces on opposite sides of the traveling lane of the subject vehicle 40 using the recognized the left-side and right-side white lines, a vehicle speed detected by the vehicle-speed sensor 11, and a yaw rate detected by the yaw rate sensor 12.

If only one of the left-side and right-side white lines of the traveling lane of the subject vehicle 40 is recognized by the recognizer 26, the predictor 23 stochastically predicts a position of the other unrecognized one of the left-side and right-side white lines based on the offset amount detected by the offset detector 21. That is, the predictor 23 is configured to calculate a probability as a function of a lateral position of a white line that the white line will be present at the lateral position. Such a probability will be hereinafter referred to as a white-line existence probability (or likelihood).

A lane width of the traveling lane of the subject vehicle 40 when the unrecognized white line becomes detectable again may be changed from a lane width of the traveling lane of the subject vehicle 40 when both the left-side and right-side white lines of the traveling lane of the subject vehicle 40 were recognized. In such a case, predicting the position of the unrecognized white line based on the same lane width as those when both the left-side and right-side white lines of the traveling lane of the subject vehicle 40 were recognized will cause a deviation of the predicted position of the unrecognized white line from its actual position. This may cause the unrecognized white line to fail to be detected or may cause a roadside object or a roadside to be incorrectly detected as a white line.

Generally, when the subject vehicle 40 is traveling straight, the subject vehicle 40 travels in the lateral center of its lane. Therefore, if there are no changes in the lane width of the traveling lane of the subject vehicle 40, the position of the subject vehicle 40 relative to each of the left-side and right-side white lines of the traveling lane of the subject vehicle 40, that is, the offset amount defined as above, will not change. A change in the offset amount implies that the lane width of the traveling lane of the subject vehicle 40 has been increased or decreased forward of the subject vehicle 40, where the position of the subject vehicle 40 may often have been changed intentionally. That is, changes in the offset amount may often correspond to changes in the lane width. Therefore, the predictor 23 may be configured to predict the position of the unrecognized white line based on the offset amount. Examples (1) to (5) of predicting the position of the unrecognized white line will now be explained.

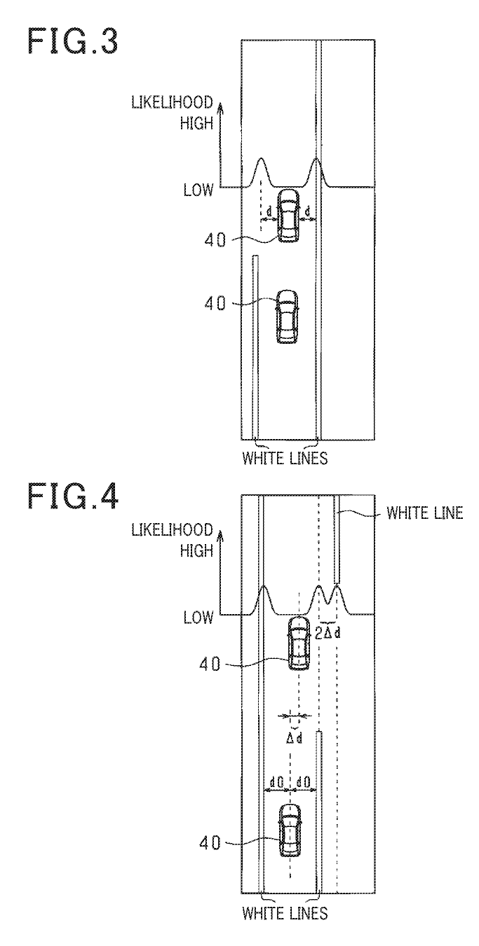

(1) The predictor 23 is configured to predict the position of the unrecognized white line based on the offset amount d detected by the offset detector 21. FIG. 3 shows an example where the right-side white line is recognized and a distance between the right side of the subject vehicle 40 and the right-side white line is detected as the offset amount d. In such an example, the predictor 23 is configured to predict a position of the right-side white line forward of the subject vehicle 40 from the position of the recognized right-side white line, and then predict a position of the left-side white line forward of the subject vehicle 40 using the predicted position of the right-side white line, the offset amount d, and a width of the subject vehicle 40. The left-side white line is predicted such that the left-side white line is laterally spaced apart from the left side of the subject vehicle 40 by the offset amount d.

The predictor 23 is configured to increase the white-line existence probability (or likelihood) to higher than a predetermined probability in a predefined area of the roadway laterally centered at the predicted position of the left-side white line. More specifically, the predictor 23 is configured to calculate the white-line existence probability such that the white-line existence probability becomes higher at a position closer to the predicted position of the left-side white line. The predictor 23 is further configured to increase the white-line existence probability (or likelihood) to higher than a predetermined probability in a predefined area of the roadway laterally centered at the predicted position of the right-side white line in a similar manner. This can prevent misrecognition of the left-side white line and can improve the performance of re-detecting the left-side white line, when the left-side white line becomes detectable again. In the following examples (2) to (5), prediction of a position of the recognized white line and calculation of the white-line existence probability may be performed in a similar manner to those described above.

(2) The predictor 23 is configured to predict a position of an unrecognized one of the left-side and right-side white lines based on at least one of a lane width detected when both the left-side and right-side white lines were recognized and a first offset amount d0 detected when both the left-side and right-side white lines were recognized. That is, the predictor 23 is configured to predict the position of the unrecognized one of the left-side and right-side white lines under an assumption that the lane width detected when both the left-side and right-side white lines were recognized is the same as the lane width detected when only one of the left-side and right-side white lines is detectable. The predictor 23 is configured to, as in the example (1), increase the white-line existence probability (or likelihood) to higher than a predetermined probability in a predefined area of the roadway laterally centered at the predicted position of the unrecognized one of the left-side and right-side white lines.

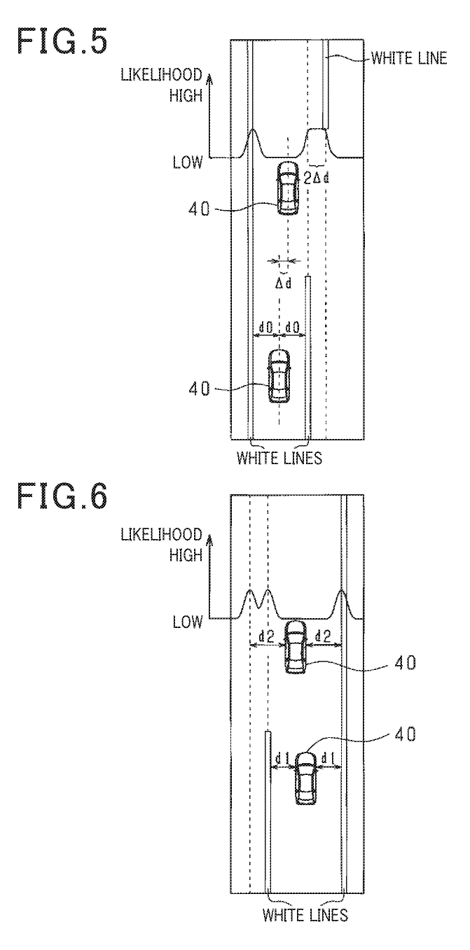

In the examples of FIGS. 4 and 5, a distance between the lateral center of the subject vehicle 40 and each of the left-side and right-side white lines is detected as a first offset amount d0 while both the left-side and right-side white lines are recognized, and then the right-side white line becomes undetectable. In FIG. 4, on the right side of the subject vehicle, a left one of two probability peaks on the right side of the subject vehicle 40 represents a white-line existence probability under an assumption that the lane width detected when both the left-side and right-side white lines were recognized is the same as the lane width detected when only the left-side white lines is detectable.

The predictor 23 is configured to, if an amount of change Δd from the first offset amount d0 detected when both the left-side and right-side white lines were recognized to an offset amount detected when only one of the left-side and right-side white lines is detectable exceeds a predetermined amount, then change the white-line existence probability based on the amount of change Δd. That is, if a difference between the first offset amount d0 detected when both the left-side and right-side white lines were recognized and the offset amount detected when one of the left-side and right-side white lines is recognized exceeds the predetermined amount, then it is determined that the lane width has changed and the white-line existence probability is changed. More specifically, the white-line existence probability is increased at a position that is laterally spaced a given multiple of the amount of change Δd apart from the position predicted under the assumption that the lane width is unchanged, that is, under the assumption that the lane width detected when both the left-side and right-side white lines were recognized is the same as the lane width detected when only one of the left-side and right-side white lines is detectable. For example, if the offset amount is changed by the amount of change Δd from the first offset amount d0 detected when both the left-side and right-side white lines were recognized, the lane width will be changed by 2Δd. In the present example as shown in FIG. 4, the given multiple of the amount of change Δd is 2Δd where the multiple factor is 2. Alternatively, the given multiple of the amount of change Δd may be set to α×Δd, where the multiple factor α may take an arbitrary value between 1 and 2. In FIG. 4, the right one of the two probability peaks on the right side of the subject vehicle 40 represents the white-line existence probability in the case that the lane width is changed.

Therefore, if the offset amount is changed with a change in the lane width, the right-side white line may become detectable again at a position of the right one of the two probability peaks on the right side of the subject vehicle 40. If the offset amount is changed with wandering of the subject vehicle 40, the right-side white line may become detectable again at a position of the left one of the two probability peaks on the right side of the subject vehicle 40. If the amount of change Δd is equal to or less than the predetermined amount, only the left one of the two probability peaks appears on the right side of the subject vehicle 40.

In the examples (3) to (5), as in the example (2), a position of an unrecognized one of the left and right white lines is predicted taking into account both the two cases. In one case, the lane width is changed. In the other case, the subject vehicle 40 is wandering while the lane width remains unchanged.

(3) The predictor 23 is, as in the example (2), configured to predict a position of an unrecognized one of the left-side and right-side white lines based on at least one of a lane width detected when both the left-side and right-side white lines were recognized and a first offset amount d0 detected when both the left-side and right-side white lines were recognized.

The predictor 23 is configured to, if an amount of change Δd from the first offset amount d0 detected when both the left-side and right-side white lines were recognized to an offset amount detected when only one of the left-side and right-side white lines is detectable exceeds a predetermined amount, then change the white-line existence probability based on the amount of change Δd. More specifically, as shown in FIG. 5, the white-line existence probability is increased between the position predicted under the assumption that the lane width is unchanged and a position that is laterally spaced a given multiple of the amount of change Δd apart from the position predicted under the assumption that the lane width is unchanged. In the present example (3), the white-line existence probability is increased between the two probability peaks on the right side of the subject vehicle 40 as calculated in the example (2), thereby calculating a single trapezoid-shaped probability peak having a large lateral extent where the white-line existence probability is maximal. This allows detection errors of the lane width and the offset amount to be accepted. If the amount of change Δd is equal to or less than the predetermined amount, only the left one of the two probability peaks calculated in the example (2) under the assumption that the lane width is unchanged is calculated to appear on the right side of the subject vehicle 40.

(4) The predictor 23 is, as in the example (2), configured to predict a position of an unrecognized one of the left-side and right-side white lines based on at least one of a lane width detected when both the left-side and right-side white lines were recognized and an offset amount d1 detected when both the left-side and right-side white lines were recognized. The predictor 23 is configured to increase the white-line existence probability (or likelihood) to higher than a predetermined probability in a predefined area of the roadway laterally centered at the predicted position of the unrecognized one of the left-side and right-side white lines.

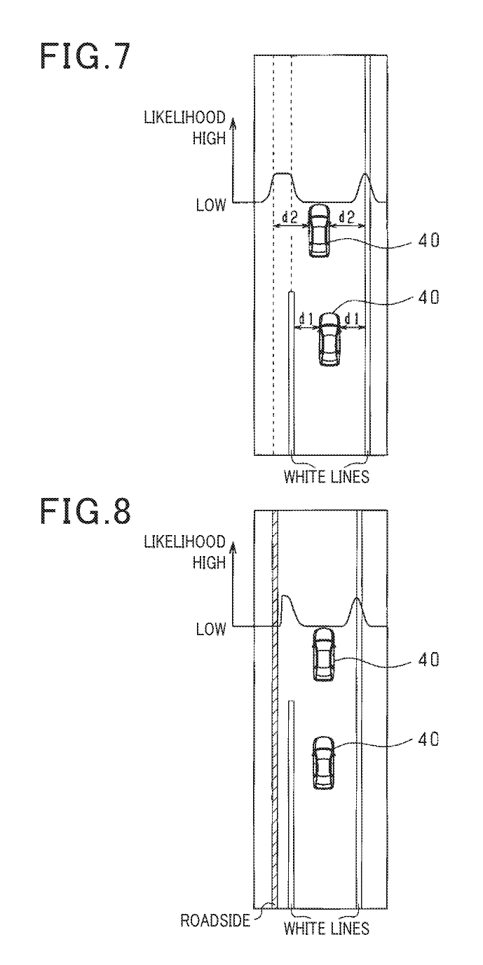

In the examples of FIGS. 6 and 7, a distance between the left/right side of the subject vehicle 40 and the left/right-side white line is detected as an offset amount d1 while both the left-side and right-side white lines are recognized, and then when the left-side white line becomes undetectable, the distance between the right side of the subject vehicle 40 and the right-side white line is detected as an offset amount d2. In FIG. 6, a right one of two probability peaks on the left side of the subject vehicle 40 represents the white-line existence probability corresponding to the offset amount d1, that is, a white-line existence probability calculated under the assumption that the lane width is unchanged between before and after disappearance of the left-side white line.

The predictor 23 is configured to increase the white-line existence probability to higher than a predetermined probability in a predefined area of the roadway laterally centered at a position that is laterally spaced the offset amount d2 apart from the left side of the subject vehicle 40. In FIG. 6, the left one of the two probability peaks on the left side of the subject vehicle 40 represents the white-line existence probability corresponding to the offset amount d2.

That is, in the example (4), a difference between the offset amount d1 and the offset amount d2 is not taken into consideration. If the offset amount d1 and the offset amount d2 are equal to each other, only the right one of the two probability peaks on the left side of the subject vehicle 40 appears.

(5) The predictor 23 is, as in the example (2), configured to predict a position of an unrecognized one of the left-side and right-side white lines based on at least one of a lane width detected when both the left-side and right-side white lines were recognized and an offset amount d1 detected when both the left-side and right-side white lines were recognized.

The predictor 23 is, as in the example (7), configured to increase the white-line existence probability between the position predicted under the assumption that the lane width is unchanged and a position that is laterally spaced the offset amount d2 apart from the left side of the subject vehicle 40. That is, the example (5) is a combination of the examples (3) and (4).

Further, as shown in FIG. 8, the predictor 23 is configured to, if only one of the left and right white lines is recognized, decrease the white-line existence probability at a position corresponding to location information of a roadside object or a roadside acquired from the map storage 13, the GPS 14, or the radar 15, on the unrecognized white line side of subject vehicle 40. This can prevent such a roadside object or a roadside from being incorrectly recognized as a white line.

The extractor 24 is configured to extract white-line candidates (as a lane partition line candidate) from a search area in a forward image captured by the vehicle-mounted camera 10. The search area includes an area where the white-line existence probability is increased by the predictor 23 to higher than the predetermined probability, and varies dependent on the position of the white line of interest predicted by the predictor 23. That is, the extractor 24 is configured to conduct the search at and around the position of the white line predicted by the predictor 23 to extract the white-line candidates.

The determiner 25 is configured to determine the clarity of each of the white-line candidates extracted by the extractor 24. More specifically, the determiner 25 is configured to determine the clarity of the white-line candidate taking into account external factors, such as backlight and rainfall. Whether or not the background is brighter than the subject due to the backlight may be determined based on the current location and the current time acquired from the GPS 14. The rainfall may be detected by a rain sensor (not shown). The white-line candidates may be blurred under the backlight or in the rainfall. Therefore, under the backlight or in the rainfall, the determiner 25 determines that each of the white-line candidates is in a bad condition where the clarity of the white-line candidate is low. Without external factors which may cause blurring of the forward image, such as the backlight and the rainfall, the determiner 25 determines that each of the white-line candidates is in a good condition where the clarity of the white-line candidate is high.

The recognizer 26 is configured to recognize one of the white-line candidates extracted by the extractor 24 having a maximum likelihood as a white line. More specifically, the recognizer 26 is configured to, in each predefined area where the white-line existence probability is increased to be higher than the predetermined probability, recognize one of the white-line candidates extracted by the extractor 24 having a maximum likelihood as a white line.

The recognizer 26 is further configured to, if it is determined by the determiner 25 that a white-line candidate extracted by the extractor 24 outside the predefined area(s) where the white-line existence probability is increased by the predictor 23 to be higher than the predetermined probability is in a good condition where the clarity of the white-line candidate is high, recognize the white-line candidate as a white line. That is, even if a white-line candidate extracted by the extractor 24 at a position that is different from the predicted white line position is in a good condition, such a white-line candidate may be determined as being a white line.

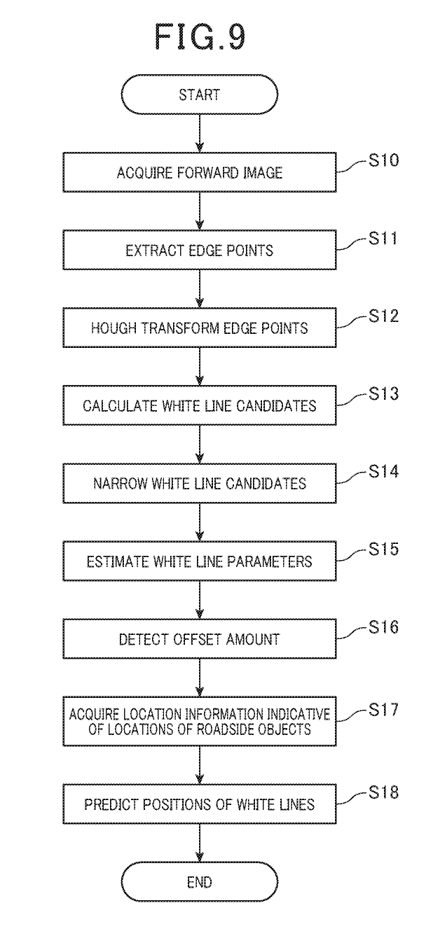

A process for recognizing the white lines (hereinafter also referred to as a white line recognition process) will now be explained with reference to a flowchart of FIG. 9. This process may be performed in the white-line recognition apparatus 20 each time the vehicle-mounted camera 10 captures the forward image.

First, in step S10, a forward image captured by the vehicle-mounted camera 10 is acquired. Subsequently, in step S11, the search area is set at and around the position of the white line predicted in the previous cycle and edge points are then extracted from the forward image by applying a Sobel filter or the like to the search area in the forward image.

In step S12, the edge points extracted in step S11 are Hough transformed. In step S13, white-line (lane partition line) candidates are extracted based on inner and outer straight lines (as inner and outer outlines of each white line candidate) calculated by the Hough transformation that satisfy predefined conditions. Each white-line candidate must satisfy the predefined conditions including a condition that a number of Hough transform votes is greater than a predetermined number and other conditions.

Subsequently, in step S14, the white-line candidates calculated in step S13 are narrowed or refined to detect one of the white-line candidates having a maximum likelihood as a white line. More specifically, for each of the white-line candidates, a probability (or likelihood) is calculated for each of the plurality of white line features based on to what degree the white-line candidate has the white line feature, and the calculated probabilities for the respective features are integrated to calculate a probability (referred to as an integrated probability) that the white-line candidate is a white line. One of the white-line candidates having a maximum integrated probability higher than a predetermined threshold is selected from the of the white-line candidates as a white line.

One of the white line features is the white line position. The white-line existence probability calculated by the predictor 23 and probabilities calculated for the other white line features are integrated together. For example, the integrated probability may be a product of the probabilities calculated for the white line features. Thus, if the predetermined probability is set to a value close to 0%, the integrated probability calculated outside the predefined area where the white-line existence probability is increased by the predictor 23 to be higher than the predetermined probability becomes lower than the threshold. Therefore, the while line will be selected from the white-line candidates calculated within the predefined area.

However, as described later, if there is no white-line candidate having the integrated probability equal to or higher than the threshold within the predefined area, a white-line candidate outside the predefined area may be selected as a white line. More specifically, if a white-line candidate calculated outside the predefined area has an integrated probability for the white line features other than the white-line existence probability that is higher than the threshold and is in a good condition in clarity, such a white-line candidate may be selected as a white line.

Alternatively, the predetermined probability may be set to slightly higher than 0%, e.g., 20%, and the predictor 23 may be configured to calculate the white-line existence probability outside the predefined area to be the predetermined probability, where the predetermined probability is such that the integrated probability can be equal to or higher than the threshold if the probabilities for the white line features other than the white-line existence probability are high enough. In such a case, if a white-line candidate calculated outside the predefined area has an integrated probability higher than the threshold and is in a good condition in clarity, such a white-line candidate may be selected as a white line. The other white line features may include the white-line continuity, the white-line contrast intensity and others.

Subsequently, in step S15, coordinates of each of the white line candidates selected in step S14 are transformed into the bird's-eye coordinates, and white line parameters are estimated in the bird's-eye coordinate system, where each of the white line candidates selected in step S14 is recognized as a white line. The white line parameters include a lane curvature, a lateral position of the vehicle 40 in the lane, a tilt angle of the traveling lane to the vehicle 40, a lane width and others.

In step S16, the offset amount indicative of a positional relationship between each white line recognized in step S14 and the subject vehicle 40 is detected. More specifically, the offset amount may be calculated based on the lateral position of the subject vehicle 40 in the lane estimated in step S15.

In step S17, the location information indicative of locations of roadside objects and roadsides is acquired based on the map information stored in the map storage 13 and the current location of the subject vehicle 40 received from the GPS 14, and the distances and directions to the three-dimensional objects detected by the radar 15.

In step S18, the position of each white line recognized in step S14 forward of the subject vehicle 40 is predicted. Then, the white-line existence probability is calculated. Thereafter, the process ends. In the above white line recognition process, for example, the offset detector 21 is responsible for execution of steps S16. The location information acquirer 22 is responsible for execution of step S17. The predictor 23 is responsible for execution of step S18. The extractor 24 is responsible for execution of steps S10-S13. The recognizer 26 and the determiner 25 are cooperatively responsible for execution of steps S14-S15.

The present embodiment described above can provide the following advantages.

(C1) Even if the lane width of the traveling lane of the subject vehicle 40 has changed during only one of the left-side and right-side white lines being recognized, the position of the unrecognized one of the left-side and right-side white lines can be predicted based on the offset amount between the recognized one of the left-side and right-side white lines and the subject vehicle 40. This can prevent a roadside object or the like from being incorrectly recognized as a white line and can improve the performance of re-detecting the unrecognized white line when it becomes detectable again.

(C2) The position of the unrecognized one of the left-side and right-side white lines is predicted based on the offset amount, and the white-line existence probability is increased at the predicted position. This allows the unrecognized one of the left-side and right-side white lines to be detected again properly when it becomes detectable again.

(C3) The white-line existence probability is increased at and around the position predicted under the assumption that the lane width is unchanged and the position predicted based on the offset amount or the amount of change in the offset amount detected when only one of the left and right white lines is recognized. Therefore, even if the lane width has changed or even if the offset amount has changed due to wandering of the subject vehicle 40 in the lane having a constant lane width, the unrecognized one of the left-side and right-side white lines can be detected again properly when it becomes detectable again.

(C4) The white-line existence probability is increased between the position predicted under the assumption that the lane width is unchanged and the position predicted based on the offset amount or the amount of change in the offset amount when only one of the left and right white lines is recognized. Therefore, even in the presence of the detection errors of the lane width or the offset amount, the unrecognized one of the left-side and right-side white lines can be detected again properly when it becomes detectable again.

(C5) If only one of the left and right white lines is recognized, the white-line existence probability is decreased at a position of a roadside object or a roadside on the unrecognized white line side of subject vehicle 40. This can prevent such a roadside object, such as a guardrail, or a roadside from being incorrectly recognized as a white line.

(C6) If a white-line candidate outside the predefined area where the white-line existence probability is increased to be higher than the predetermined probability is in a good condition where the clarity of the white-line candidate is high, such a white-line candidate is recognized as a white line. This can further enhance the capability of detecting an unrecognized one of the left-side and right-side white lines when it becomes detectable again.

(C7) Taking into account not only the forward image captured by the vehicle-mounted camera 10, but also the external factors, allows the clarity of each white-line candidate to be determined properly.

### Modifications

It is to be understood that the invention is not to be limited to the specific embodiment disclosed above and that modifications and other embodiments are intended to be included within the scope of the appended claims.

(i) In the above embodiment, the predictor 23 is configured to decrease the white-line existence probability with increasing distance from the predicted position. Alternatively, for example, the predictor may be configured to decrease the white-line existence probability in steps away from the predicted position.

(ii) The clarity of each white-line candidate may be determined based only on the forward image captured by the vehicle-mounted camera 10.

(iii) All the white-line candidates detected outside the predefined area may be ignored.

What is claimed is:

1. A lane partition line recognition apparatus for recognizing left-side and right-side lane partition lines of a traveling lane of a roadway in which a vehicle carrying the apparatus is traveling based on a forward image captured by a vehicle-mounted camera, the vehicle carrying the apparatus being hereinafter referred to as a subject vehicle, the apparatus comprising:
an offset detector configured to detect an offset amount indicative of a positional relationship between each of the left-side and right-side recognized lane partition lines and the subject vehicle; and
a predictor configured to, if only one of the left and right lane partition lines of the traveling lane of the subject vehicle is recognized, stochastically predict a position of the unrecognized one of the left and right lane partition lines based on the offset amount detected by the offset detector.

2. The apparatus of claim 1, wherein the predictor is configured to, if only one of the left and right lane partition lines of the traveling lane of the subject vehicle is recognized, predict a position of the unrecognized one of the left and right lane partition lines based on the offset amount detected by the offset detector, and increase a lane partition line existence probability at the predicted position of the unrecognized one of the left and right lane partition lines.

3. The apparatus of claim 1, wherein
the predictor is configured to, if only one of the left and right lane partition lines of the traveling lane of the subject vehicle is recognized,
predict a position of the unrecognized one of the left-side and right-side lane partition lines based on at least one of a lane width detected when both the left-side and right-side lane partition lines were recognized and a first offset amount detected by the offset detector when both the left-side and right-side lane partition lines were recognized, and increase the lane partition line existence probability at the predicted position, and
if an amount of change from the first offset amount detected by the offset detector when both the left-side and right-side lane partition lines were recognized to an offset amount detected by the offset detector when only one of the left-side and right-side lane partition lines is recognized exceeds a predetermined amount, then change the lane partition line existence probability based on the amount of change.

4. The apparatus of claim 1, wherein
the predictor is configured to, if only one of the left and right lane partition lines of the traveling lane of the subject vehicle is recognized, predict a position of the unrecognized one of the left-side and right-side lane partition lines based on at least one of a lane width detected when both the left-side and right-side lane partition lines were recognized and a first offset amount detected by the offset detector when both the left-side and right-side lane partition lines were recognized, and increase the lane partition line existence probability at the predicted position, and
if an amount of change from the first offset amount detected by the offset detector when both the left-side and right-side lane partition lines were recognized to an offset amount detected by the offset detector when only one of the left-side and right-side lane partition lines is recognized exceeds a predetermined amount, then increase the lane partition line existence probability at a position that is spaced a given multiple of the amount of change apart from the predicted position.

5. The apparatus of claim 1, wherein
the predictor is configured to, if only one of the left and right lane partition lines of the traveling lane of the subject vehicle is recognized, predict a position of the unrecognized one of the left-side and right-side lane partition lines based on at least one of a lane width detected when both the left-side and right-side lane partition lines were recognized and a first offset amount detected by the offset detector when both the left-side and right-side lane partition lines were recognized, and increase the lane partition line existence probability at the predicted position, and
if an amount of change from the first offset amount detected by the offset detector when both the left-side and right-side lane partition lines were recognized to an offset amount detected by the offset detector when only one of the left-side and right-side lane partition lines is recognized exceeds a predetermined amount, then increase the lane partition line existence probability between the predicted position and a position that is spaced a given multiple of the amount of change apart from the predicted position.

6. The apparatus of claim 1, wherein
the predictor is configured to, if only one of the left and right lane partition lines of the traveling lane of the subject vehicle is recognized,
predict a position of the unrecognized one of the left-side and right-side lane partition lines based on at least one of a lane width detected when both the left-side and right-side lane partition lines were recognized and the offset amount detected by the offset detector when both the left-side and right-side lane partition lines were recognized, and increase the lane partition line existence probability at the predicted position, and
on a lane-unrecognized side of the subject vehicle, increase the lane partition line existence probability at a position that is spaced apart from the subject vehicle by an offset amount detected by the offset detector.

7. The apparatus of claim 1, wherein
the predictor is configured to, if only one of the left and right lane partition lines of the traveling lane of the subject vehicle is recognized,
predict a position of the unrecognized one of the left-side and right-side lane partition lines based on at least one of a lane width detected when both the left-side and right-side lane partition lines were recognized and the offset amount detected by the offset detector when both the left-side and right-side lane partition lines were recognized, and increase the lane partition line existence probability at the predicted position, and
on a lane-unrecognized side of the subject vehicle, increase the lane partition line existence probability between the predicted position and a position that is spaced apart from the subject vehicle by an offset amount detected by the offset detector.

8. The apparatus of claim 1, further comprising a location information acquirer configured to acquire information indicative of locations of roadside objects or roadsides of the roadway,
wherein the predictor is further configured to, if only one of the left and right lane partition lines of the traveling lane of the subject vehicle is recognized, decrease the lane partition line existence probability at a position or positions indicated by the information acquired by the location information acquirer on a lane-unrecognized side of the subject vehicle.

9. The apparatus of claim 1, further comprising:
an extractor configured to extract lane partition line candidates from the forward image captured by the vehicle-mounted camera;
a recognizer configured to recognize one of the white-line candidates extracted by the extractor having a maximum likelihood as a white line on each of the left and right sides of the subject vehicle; and
a determiner configured to determine the clarity of each of the white-line candidates extracted by the extractor,
wherein the recognizer is further configured to, if it is determined by the determiner that a white-line candidate extracted by the extractor outside a predefined area where the lane partition line existence probability is increased by the predictor is in a good condition in clarity, recognize the white-line candidate as a white line.

10. The apparatus of claim 9, wherein the determiner is configured to determine the clarity of each of the white-line candidates taking into account external factors.

11. The apparatus of claim 10, wherein the external factors include backlight and rainfall.
